(19) United States
(12) Patent Application Publication
(10) Pub. No.: US 2026/0316983 A1
(43) Pub. Date: Oct. 15, 2026

(54) DEVICE FOR CHARGING A FEEDING SYSTEM FOR PACKAGING MEDICAMENTS

(71) Applicants: Daniel HIDDINK, Neuheim (CH); HMH SYSTEMS AG, Huenenberg (CH)

(72) Inventor: Daniel Hiddink, Neuheim (CH)

(21) Appl. No.: 19/481,116

(22) PCT Filed: May 3, 2024
(86) PCT No.: PCT/IB2024/054291

§ 371 Date: Nov. 3, 2025

(30) Foreign Application Priority Data
May 3, 2023 (CH) 000478/2023
Jun. 19, 2023 (CH) 000653/2023

(51) Int. Cl. B65B 39/00

(52) U.S. Cl. CPC B65B 39/001; B65B 39/005

(57) ABSTRACT

An apparatus for charging a feeding system for packaging medicaments, where the feeding system includes a feeding box. The apparatus includes a three-dimensional robot having a charging container arranged on the three-dimensional robot. The charging container can be filled at a filling station using the three-dimensional robot, and can be emptied over the feeding system using the three-dimensional robot. Each of the charging container and the filling station include shut-off slides.

The present application is the U.S. national phase of PCT Application PCT/IB2024/054291 filed on May 3, 2024, which claims priority of Swiss patent application No. CH000478/2023, filed on May 3, 2023, and of Swiss patent application no. CH000653/2023 filed Jun. 19, 2023, both of which are incorporated herein by reference in their entireties.

### TECHNICAL FIELD

The present invention relates to a device for charging a feeding system for packaging medicaments.

### BACKGROUND

Pharmaceutical products such as pills, tablets, capsules and the like are often packaged in disposable packaging before being shipped to consumers. Such disposable packaging includes thermoformed and cold-formed blister packs as well as pouches, bags or disposable bottles.

An important aspect in the manufacture of these packages is the placement of the pills in the blister packs before application of a sealing film layer. This process is preferably carried out by an automatic machine capable of placing the pills precisely and accurately at high speed. One embodiment of a blister packaging machine is known, for example, from the document U.S. Pat. No. 5,737,902. The feeding system described therein comprises a feeding cassette with number of tubes and a chute arrangement with several chutes for guiding individual pills into the corresponding container. Above the feeding cassette is an orientation plate which guides the tablets into the feeding cassette, which in turn guides the tablets into the chutes.

A hopper, which is arranged above the feeding cassette of the feeding system, is closed off from the tubes by the orientation plate. The hopper filled with tablets that are to be packaged performs an up-and-down movement, in order to separate and orient the tablets into the tubes so that these tablets can be fed sequentially through the tubes to the chutes and a simultaneous and precise filling from all of the chutes into corresponding tablet cavities of blister packs can take place. This is because a blister pack can be used for sale only when all of the tablet cavities of the blister pack each contain a tablet.

Conventional feeding systems are charged with the bulk material to be packaged by means of known conveyor systems, which conveyor systems usually combine belt conveyors and lifting conveyors and have little flexibility for adaptation to changing conditions.

There is a need, therefore, to further develop a device for charging a feeding system for packaging medicaments, so as to make available an improved device which permits largely automatic charging and which at the same time offers a high degree of flexibility in terms of freedom of movement and adaptability to changing conditions.

### SUMMARY

The above-stated need, as well as others, are addressed by one or more embodiments disclosed herein.

One aspect of a first embodiment, as regards the device for charging a feeding system for packaging medicaments, having a feeding system with a feeding box, is that this charging device comprises a three-dimensional robot with a charging container arranged on said robot, wherein, by means of the robot, this charging container can be filled at a filling station and can be emptied over the feeding system. The feeding system can thus be filled or emptied in a simple manner and with a high degree of flexibility. Any conversion needed on account of changed conditions can also be carried out quickly and easily by means of the device according to the invention.

In some embodiments, it is advantageously provided that the robot is arranged in a stationary manner between the filling station and the feeding system; for conversion in the event of changed packaging conditions, the robot can in this case remain in place and the filling station and/or the feeding system are adapted according to the changed packaging conditions.

In other embodiments, it is advantageously provided that the robot is arranged so as to be movable between the filling station and the feeding system; this robot can thus be easily moved to its respective place of use.

It is also advantageous if the charging container and the filling station each have a closure slide which is able to be opened or closed for the purpose of filling or emptying the charging container. The feeding system advantageously also comprises a closure slide, and the two closure slides of the charging container and of the feeding system are arranged such that they are movable relative to each other for the purpose of filling the feeding system and are thus able to be opened or closed.

### BRIEF DESCRIPTION OF THE DRAWINGS

In the figures, which are purely schematic:

FIG. 1 shows a perspective view of a feeding system for medicaments, which is shown by way of introduction by means of a device according to the disclosure for charging such a feeding system;

FIG. 2 shows the device according to the disclosure for charging a feeding system by means of a three-dimensional robot;

FIG. 3 shows a perspective view of the device according to the disclosure with a charging container, which can be filled by means of the three-dimensional robot at a filling station;

FIG. 4 shows a perspective view of the device according to the disclosure with the charging container at a feeding system, which also;

FIG. 5 shows a perspective view of the device according to the disclosure with the charging container directly above the feeding system;

FIG. 6 shows a perspective view of the device according to the disclosure with the charging container in an inclined position directly above the feeding system;

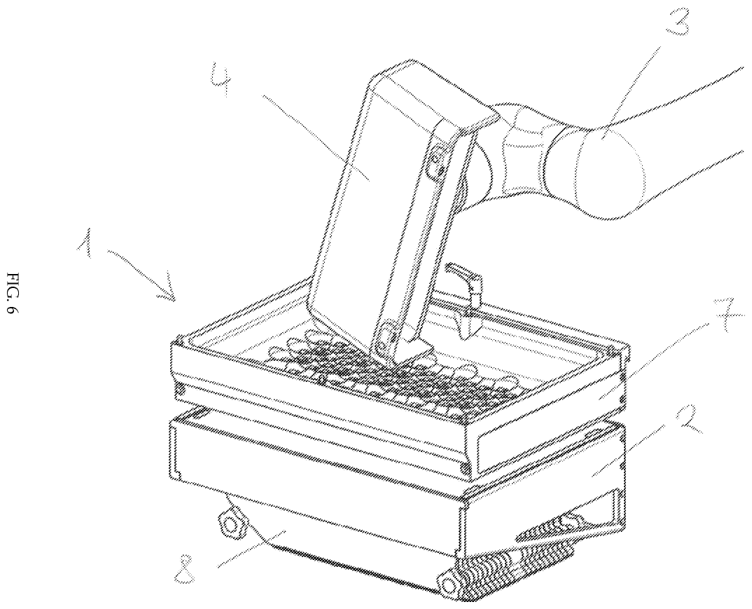

FIGS. 7a-c show a sectional view of the device according to the disclosure with a charging container at the filling station according to FIG. 3, wherein respective closure slides of the charging container and of the filling station are simultaneously opened in opposite directions for the purpose of filling the charging container-sequence from FIG. 7a to FIG. 7c—or closed—sequence from FIG. 7c to FIG. 7a.

### DETAILED DESCRIPTION

Exemplary embodiments are explained below by way of example and by reference to figures. In the figures, identical objects are generally provided with the same reference signs. At this point, it should be noted that the figures have no limiting effect on the subject matter of the present invention as such, and instead they merely show exemplary embodiments of the inventive concept-as it is presented in the claims.

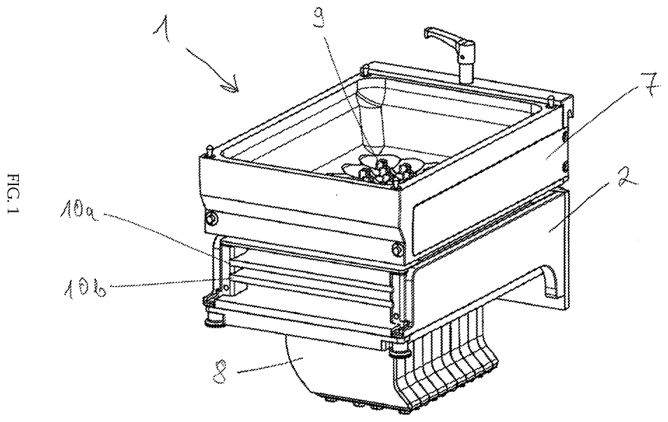

By way of introduction to the present subject matter, FIG. 1 shows a perspective view of a feeding system 1, with which tablets, pills or capsules (not explicitly shown here) can be introduced into packages (also not shown) via a hopper 7 for receiving same, and via a feeding box 2 with a downstream chute arrangement 8. In the example shown here of a hopper 7 that is open at the top, the tablets, pills or capsules can be introduced into it and fed by means of tubes 9 leading from it to the feeding box 2, which comprises pin plates for the purpose of separating individual tablets, pills or capsules.

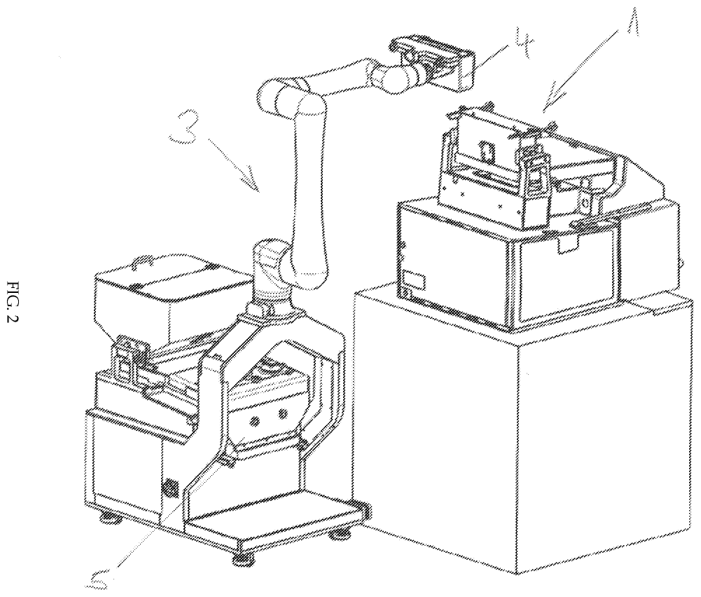

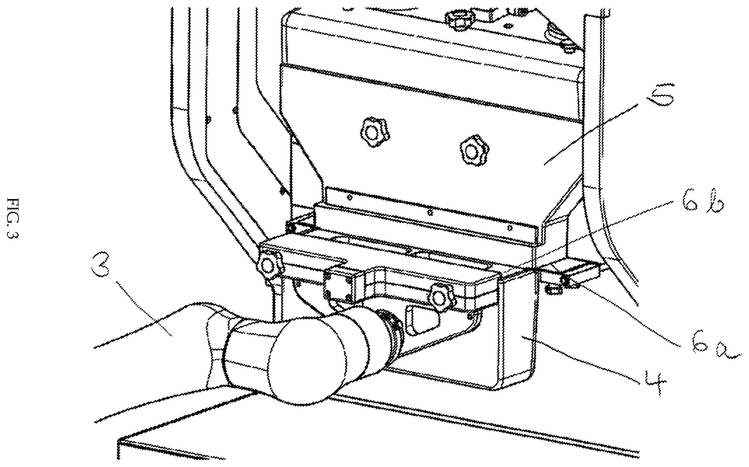

FIG. 2 shows the device according to the disclosure for charging the feeding system 1 shown in more detail in FIG. 1, wherein this device for charging the feeding system 1 with tablets, pills or capsules comprises a three-dimensional robot 3 with a charging container 4 arranged on said robot 3, and wherein, by means of the robot 3, this charging container 4 can be filled at a filling station 5 and can be emptied over the feeding system 1. FIG. 3 shows the robot 3 in a position in which the charging container 4 can be brought into an operative connection with the filling station 5. For this purpose, closure slides 6b and 6a can be provided on the charging container 4 and the filling station 5, respectively, which closure slides are either opened or closed in the event. In any case, according to the disclosure, the robot 3 guides the charging container 4 to the filling station 5 in such a way that the charging container 4 can be filled with tablets, pills or capsules (not explicitly shown here).

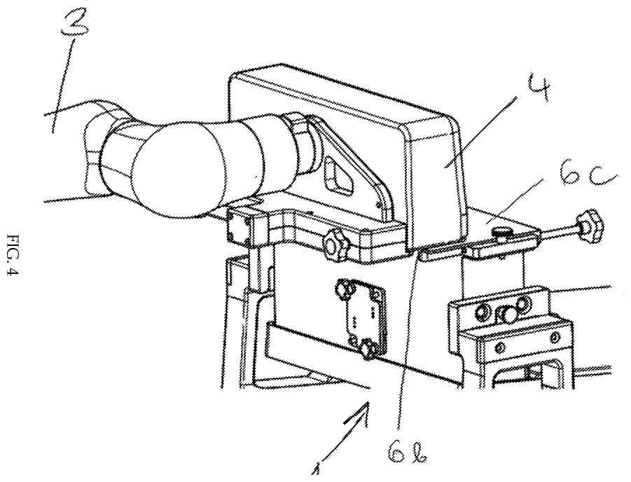

FIG. 4 now shows, in a subsequent position, the robot 3 which guides the charging container 4 to the feeding system 1. For this purpose, the closure slide 6b on the charging container 4 and a closure slide 6c on the feeding system 1 are opened simultaneously in order to feed the contents of the charging container 4, namely tablets, pills or capsules, to the feeding system 1. Of particular advantage is an embodiment in which the feeding system 1, the charging container 4 and the filling station 5 are each equipped with the closure slide 6a, b, c, since both the filling of the charging container 4 at the filling station 5 and the emptying of the charging container 4 at the feeding system 1 can thereby take place in a substantially closed manner, i.e. neither bulk material—such as tablets, pills or capsules—nor the dust associated with bulk material will escape during filling or emptying. Thus, the device according to the present embodiment for charging the feeding system allows a possibility of particularly clean and simple filling.

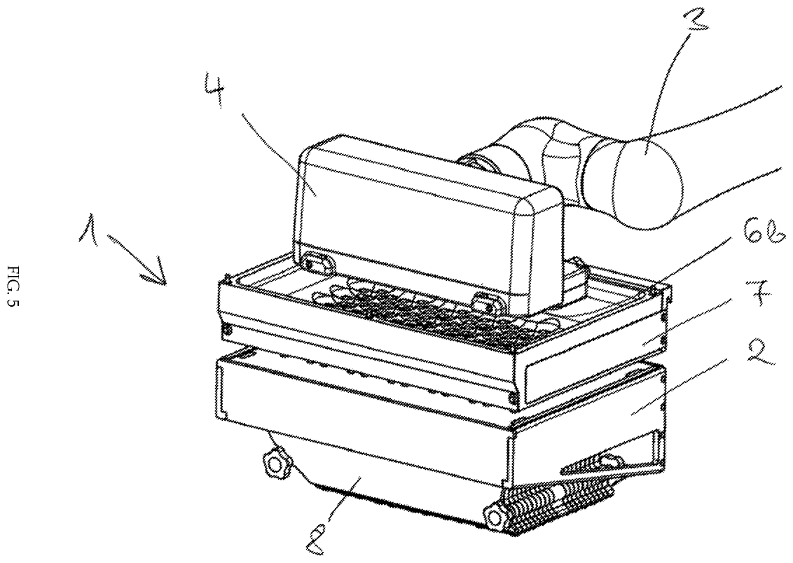

FIG. 5 shows an embodiment in which only the charging container 4 comprises the closure slide 6b, wherein the charging container 4 can be emptied by means of the robot 3 over the open hopper 7 of the feeding system 1 by actuation of this closure slide 6b. In a further, simplified embodiment, neither the charging container 4 nor the feeding system 1 has the closure slide, and the robot 3 guides the charging container 4 over the hopper 7 of the feed system for pouring purposes.

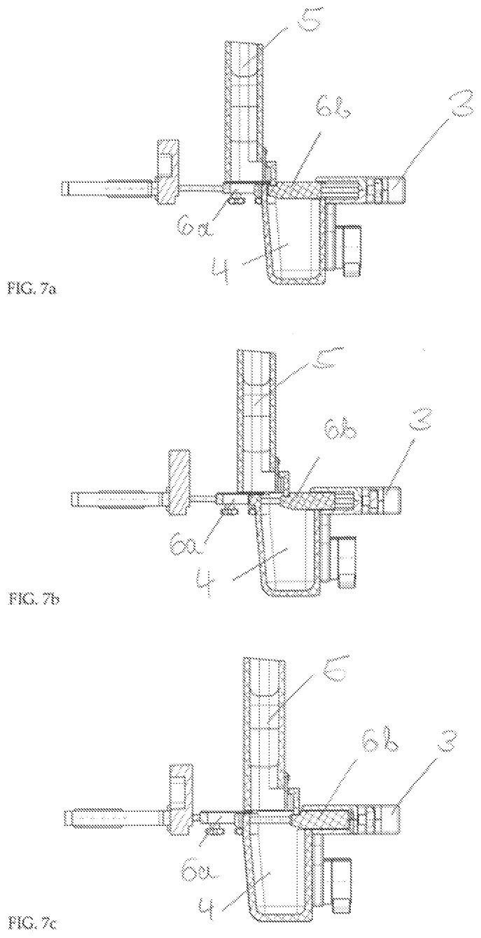

FIGS. 7a to 7c show in chronological order how the closure slide 6a of the filling station 5 and the closure slide 6b of the charging container 4 are brought into mutual engagement for parallel actuation. For this purpose, the robot 3 is used to guide the two closure slides 6a, 6b to or onto each other at their respective edges in such a way that they open simultaneously by corresponding movement of the robot 3 or close simultaneously when separated. FIG. 7a shows the charging container 4, which has been guided to the filling station 5 by the robot 3, specifically in such a way that lateral edges of the two closure slides 6a, b abut each other. FIG. 7b shows a slightly opened position of the two closure slides 6a, b, the robot 3 having brought these closure slides 6a, b into this position. The two closure slides 6a, b are shown fully opened in FIG. 7c. In this position, the charging container 4 can be filled with tablets, pills or capsules from the filling station 5. Corresponding to this filling procedure shown chronologically in FIGS. 7a to 7c, the emptying of the charging container 4 can also take place at the feeding system as shown in FIG. 4, wherein the closure slides 6b and 6c can then be brought into a corresponding operative connection with each other by means of the robot.

### LIST OF REFERENCE SIGNS

1 feeding system
2 feeding box
3 robot
4 charging container
5 filling station
6a, b, c closure slide
7 hopper
8 chute arrangement
9 tube
10a, 10b pin plates for separation

1.-6. (canceled)

7. An apparatus for charging a feeding system for packaging medicaments, the feeding system comprising a feeding box, the apparatus comprising:
a three-dimensional robot having a charging container arranged on the three-dimensional robot, wherein, wherein the charging container can be filled at a filling station using the three-dimensional robot, and can be emptied over the feeding system using the three-dimensional robot; and
wherein each of the charging container and the filling station include shut-off slides.

8. The apparatus as claimed in claim 7, wherein the three-dimensional robot is arranged in a stationary manner between the filling station and the feeding system.

9. The apparatus as claimed in claim 7, wherein the three-dimensional robot is arranged to be movable between the filling station and the feeding system.

10. The apparatus as claimed in claim 7, wherein, for filling the charging container at the filling station, the shut-off slide of the charging container is configured to open and close relative to the shut-off slide of the filling station.

11. The apparatus as claimed in claim 10, wherein the three-dimensional robot is configured to guide the shut-off slide of the charging container such that an edge of the shut-off slide of the charging container engages an edge of the shut-off slide of the filling station such that that the shut-off slide of the charging container and the shut-off slide of the filling station open simultaneously by corresponding movement of the robot.

12. The apparatus as claimed in claim 10, wherein the three-dimensional robot is configured to guide the charging container such that the shut-off slide of the charging container and the shut-off slide of the filling station close simultaneously by corresponding movement of the robot.

13. The apparatus as claimed in claim 7, wherein, for filling the feeding system using the charging container, a closure slide is arranged on the feeding system, and the shut-off slide of the filling station is further configured to open or close relative to the closure slide.

14. An apparatus for charging a feeding system for packaging medicaments, the feeding system comprising a feeding box; the apparatus comprising:
a filling station configured to provide medicaments via an opening having a shut-off slide;
a three-dimensional robot having a charging container arranged on the three-dimensional robot, wherein, the three-dimensional robot configured to move the charging container to a position in which that charging container can be filled at a filling station, and further configured to move the charging container into a further position where the charging container can be emptied over the feeding system using the three-dimensional robot; and
wherein each of the charging container includes a shut-off slide that is configured to cooperate with the shut-off slide of the filling station such that filling of the charging container at the filling station take place in a substantially closed manner.

15. The apparatus as claimed in claim 14, wherein the three-dimensional robot is arranged in a stationary manner between the filling station and the feeding system.

16. The apparatus as claimed in claim 14, wherein the three-dimensional robot is arranged to be movable between the filling station and the feeding system.

17. The apparatus as claimed in claim 14, wherein, for filling the charging container at the filling station, the shut-off slide of the charging container is configured to open and close relative to the shut-off slide of the filling station.

18. The apparatus as claimed in claim 17, wherein the three-dimensional robot is configured to guide the shut-off slide of the charging container such that the edge of the shut-off slide of the charging container engages the edge of the shut-off slide of the filling station such that that the shut-off slide of the charging container and the shut-off slide of the filling station open simultaneously by corresponding movement of the robot.

19. The apparatus as claimed in claim 18, wherein the three-dimensional robot is configured to guide the charging container such that the shut-off slide of the charging container and the shut-off slide of the filling station close simultaneously by corresponding movement of the robot.

20. The apparatus as claimed in claim 14, wherein, for filling the feeding system using the charging container, a closure slide is arranged on the feeding system, and the shut-off slide of the filling station is further configured to open or close relative to the closure slide.
